(19) United States
(12) Patent Application Publication
(10) Pub. No.: US 2019/0290404 A1
(43) Pub. Date: Sep. 26, 2019

(54) DENTAL IMPLANT SYSTEM

(71) Applicant: Z-Systems AG, Oensingen (CH)

(72) Inventor: Ernst Thomke, Grenchen (CH)

(21) Appl. No.: 16/359,181

(22) Filed: Mar. 20, 2019

(30) Foreign Application Priority Data
Mar. 22, 2018 (CH) 00392/18

(51) Int. Cl. A61C 8/00

(52) U.S. Cl. CPC A61C 8/0068; A61C 8/0051; A61C 8/008; A61C 8/0018; A61C 8/0012; A61C 8/006; A61C 8/0074; A61C 8/0069

(57) ABSTRACT

A dental implant system includes an anchoring part of a ceramic material and an insertion tool. The anchoring part includes an outer thread that defines an axis. The anchoring part has a recess for an engagement of a fastening post of an abutment as well as for an engagement of an insertion tool, the recess being open towards the coronal end. The recess has an inner structure region with an inner structure that forms an insertion geometry for interacting with a corresponding outer structure of the insertion tool, and the insertion tool has an engagement portion with the corresponding outer structure. The recess forms a support region coronally of the inner structure region, wherein a transition region with a surface which in the longitudinal section is concavely arcuate and/or conical is formed between the support region and the inner structure region.

### BACKGROUND OF THE INVENTION

### Field of the Invention

The invention relates to the field of medical technology. It also relates to a dental implant system.

### Description of Related Art

Two-part implant systems are widespread amongst dental implant systems. These include the actual implant (also called “anchoring part” or, if it is provided with a thread, “screw”) and an abutment which is provided for fastening thereto. The anchoring part can herein be designed such that it is introduced roughly flush with the bone surface (as a so-called bone-level implant), or it can be provided with a region coronally of the bone surface, the region often being widened with respect to the enossal region, which is generally provided with a thread, sometimes being called a “tulip” and being envisaged to reach to roughly the gum surface. Implants with such a transgingival region are called “tissue level” implants. The region (“post”) that projects out of the gums and that serves for the fastening of a superstructure, thus a crown, bridge or prosthesis or the like, in the two-part implant system is formed by the abutment.

Apart from the well-established titanium, ceramic materials are gaining increasing significance, amongst these in particular zirconium oxide ceramics (also called “zirconium” which scientifically is not entirely correct). Ceramic implants have aesthetic advantages due to their colour and furthermore they encourage the integration of bone tissue and gingival tissue on the implant surface particularly well and are often met with a greater acceptance by patients than metallic implants. However, they have the disadvantage that they are brittle-hard and in contrast to the more ductile metallic implants have a tendency to brittle fracture given large mechanical loads. Accordingly, not all implant shapes can be manufactured without further consideration.

In particular, this is probably due to the fact that large shear forces can result at the coronal end on rotating in (inserting) the implant on the bone tissue by way of an insertion tool (rotating-in tool or abutment driver). Such shear forces can be a cause of the mentioned brittle breakages. The material thickness is often particularly thin at the coronal end on account of a coronally open recess (“inner bore”), into which the abutment engages.

DE 20 2008 016 278 U discloses a dental implant system with an implant part and an abutment that are connectable to one another via a self-locking connection with two cones that engage into one another. The implant system also includes a screwdriver-like insertion tool (rotating-in tool).

US 2010/0248181 discloses a dental implant system with an implant and an insertion tool. The insertion tool engages into a recess in the implant, the recess including a conical region and an indexed region apically of this. The insertion tool includes a conical portion corresponding to the conical region. This portion is supported on a region at the coronal end of the conical region when the insertion tool is inserted into the recess, whereas no support takes place apically of this. On account of this, a conical self-locking can result if a tightening screw is used, in order to tighten or clamp the insertion tool against the implant. Such an approach is to lead to a part of the torque being able to be transmitted via the self-locking cone connection. What is disadvantageous is the fact that significant forces must be mustered on releasing the tool from the implant. This approach is therefore not suitable for brittle-hard ceramic implants. In contrast, the construction seems to be somewhat disadvantageous with regard to the challenge, outlined above, of avoiding large shear forces at the coronal end.

### SUMMARY OF THE INVENTION

It is the object of the present invention to provide a two-part implant system, an anchoring part and an insertion tool as well as an implantation set with an anchoring part and an insertion tool, which overcome the disadvantages of the state of the art and in particular are designed such that a failure during the implantation of the anchoring part is less probable.

According to an aspect of the invention, a dental implant system is provided, which includes:
an anchoring part for anchoring in bone tissue, wherein the anchoring part is manufactured of a ceramic material,
wherein the anchoring part includes an outer thread, which defines an axis,
wherein the anchoring part includes a recess for an engagement of a fastening post of an abutment as well as for an engagement of an insertion tool, the recess being open towards a coronal end,
and the corresponding insertion tool,
wherein the recess includes an inner structure region with an inner structure that forms an insertion geometry for interacting with a corresponding outer structure of the insertion tool, and wherein the insertion tool includes an engagement portion with the corresponding outer structure,
wherein the recess coronally of the inner structure region forms a—for example conical—support region, wherein a transition region with a surface that, in the longitudinal section, is concavely arcuate and/or conical (wherein in the later case the cone angle is steeper than the cone angle of the support region) is formed between the support region and the inner structure region,
wherein the insertion tool coronally of the engagement portion forms a widening that merges via a transition portion into the engagement portion,
and wherein a surface of the insertion tool is convexly arcuate in a two-dimensional manner in the region of the transition portion, i.e. is arcuate in a longitudinal section, so that a wedging connection between the insertion tool and the anchoring part results in this region.

The wedging connection results if the insertion tool is correctly inserted into the recess up to the stop that is formed by the abutting of the transition portion on the transition region.

The wedging connection may in embodiments be a viewed as a gripping connection, due to an interference fit between the insertion tool and the anchoring part, especially in interference fit along a line.

What is meant by a “longitudinal section” is a section along a plane that is led through the axis and is parallel to said axis.

The wedging connection has the advantage that for implantation, the implant holds on the tool without aids being necessary for this. In contrast to a wedging connection with particularly shallow cones that engage into one another, this wedging connection however is simple to release, which is also why hardly any risk of a breakage exists on removing the tool, in contrast to a wedging in a conical region.

Concerning implants with a, for example, conical support region, the insertion tool in principle could form a support portion that engages into the support region, so that the anchoring part holds on the insertion tool when the implantologist positions it. This however would be problematic. Firstly, the opening angle of the cone would have to be very small, so that a self-locking fit (Morse taper fit) results, which can be problematic. Secondly, the problem arises of the insertion tool being connected to the anchoring part in a relatively firm manner after a large coupling-in of force during the implantation process. For this reason, damage to the anchoring part or even to the bone tissue can result on removing the insertion tool, for example if the implantologist applies a force which also acts at a small angle to the axis. If for this reason one forgoes a support portion of the insertion tool, then other measures would have to be provided, so that the anchoring part holds on the insertion tool—see for example WO 2017/096494—and furthermore on inserting, axial forces are applied from the insertion tool onto the anchoring part, under certain circumstances at locations which are only limitedly loadable.

It is here that the invention provides a remedy, by way of the axial position of the insertion tool being defined and axial forces occurring in the support region, which is also envisaged for this, whereas, as mentioned, the wedging connection holds the implant on the tool.

The support region can be designed conically and can interact with a corresponding conical portion of the abutment, in order to fix this abutment particular well on the anchoring part and to accommodate the large axial forces that occur, for example, on chewing.

A guide portion which forms the widening can be formed on the insertion tool, the shape of the guide portion corresponding roughly to that of the support region—in particular the guide portion can also be conical and have the same cone angle if the support region is conical. This however does not serve as a stop. In contrast, the guide portion can be mounted within the recess in a floating manner, indeed by way of the transition portion forming the stop and defining the relative position.

The shape of the recess in the support region and the shape of the insertion tool can therefore be matched to one another such that when the insertion tool is inserted up to the stop, a gap is formed between the insertion tool and the inner wall of the recess at least regionally along the periphery. Such a gap can be peripheral, thus extend around the complete periphery at least at the coronal end or at another axial position, wherein however one does not rule out a contacting also taking place given an elastic deformation. The thickness (radial extension) of the gap can be constant or non-constant in the peripheral direction and in the axial direction.

Given a conical guide portion, the transition portion between the widening/guide portion and the engagement portion in particular begins at an axial position, at which the cone diameter is somewhat smaller than the diameter of the conical support region at its apical end, so that on inserting the insertion tool apically in the axial direction, the transition portion abuts on the transition region, before the conical guide portion contacts the conical support region, i.e. without the conical guide portion having to contact the conical support region.

A further advantage of the procedure according to the invention manifests itself given the presence of a conical guide portion, wherein this advantage is moreover independent of the conicity of a portion coronally of the transition portion. This is due to the manufacturing technology. In contrast to a, for example, conical fit, the shape of the insertion tool does not have to be adapted to the shape of the recess in an exactly perfect manner; tolerances exist. The system is functioning as long as the transition portion, which is arcuate in the longitudinal section, abuts on the transition region, and specifically independently of the exact position of the wedging seat (forming a peripheral line).

The transition region can be concavely arcuate, in particular in the longitudinal section, wherein the curvature is then smaller than the curvature of the transition portion. As an alternative, the transition region can be conical, as mentioned. In both cases, the convexly arcuate transition portion engages on the transition region such that it is not a conical self-locking connection that results there as in the state of the art, but a wedging connection along a line that is peripheral about the transition portion, which is convexly arcuate in the longitudinal section, or along a peripheral strip, the wedging connection being much simpler to release.

In particular, an inner thread can be present apically of the insertion geometry region (of the region of the recess, in which the engagement portion interacts with the insertion geometry). This inner thread serves for fastening the abutment by way of an abutment screw (also called occlusal screw).

The implant system can further include the abutment with the fastening post for engaging into the recess. Herein, the abutment is preferably likewise ceramic, since the advantages of a ceramic implant system are particularly pronounced with ceramic abutments.

An abutment screw—metallic or likewise from a ceramic material—can belong to the implant system. Such an abutment screw includes an outer thread. The abutment can then be designed in a sleeve-like manner and includes a continuous opening (an abutment screw channel). The abutment screw can be received into the opening of the abutment and fastened on the implant via the outer thread—in particular possibly on the insert element—by which means the abutment can be pressed against the implant in a manner known per se. For this purpose, the abutment screw can include a screw head and a shoulder formed on the continuous opening, on which shoulder the apically facing surface of the screw head abuts, in order to press the abutment against the implant.

The ceramic material of the anchoring part (and possibly of the abutment) can be an oxide ceramic, for example a ceramic based on zirconium oxide, in particular a zirconium-oxide-based ceramic which is yttrium-stabilised. Ceramics based on aluminium oxide can also be used.

In particular, the anchoring part can be designed as a bone-level anchoring part (subgingival implant), i.e. in its entirety it belongs to the enossal part of the implant system and is shaped such that it is envisaged for being sunk down to the bone crest height, which for example excludes the presence of a coronal (transgingival) region which widens substantially with respect to the thread. However, it can also be designed differently, for example as a tissue-level anchoring part.

The arrangement of the insertion geometry apically of the support region permits a force transmission into a region that is already arranged enossally during the rotating-in. Apart from the aforementioned advantages, this creates the further advantage that a twisting of the implant can be prevented by way of this.

The insertion geometry (i.e. the axial region (insertion geometry region) of the recess, in which the insertion geometry is arranged) in its axial course can, in particular, be cylindrical, i.e. translationally symmetrical along the axis or, for example, be conical or concave or possibly convex. In a cross section perpendicular to the axis, the insertion geometry according to definition is not rotationally symmetrical. In particular, the inner structure can have an n-fold rotation axis in the region of the insertion geometry, wherein n is a natural number larger than 1. An oval, polygonal shapes (triangle, rectangle, pentagon, hexagon, etc.) possibly with rounded corners, a curve of constant thickness, a star shape or flower shape are examples of insertion geometry cross-sectional shapes.

The outer structure of the engagement portion of the insertion tool corresponds, for example, essentially to the insertion geometry, so that an accurately fitting insertion is possible; the insertion geometry and the engagement portion can therefore correspond to one another in their cross-sectional shape. However, one does not rule out the outer structure of the insertion tool only regionally following the insertion geometry. For example, the engagement portion does not necessarily need to extend to outermost edges and/or a regular external hexagon can be fitted into an equilateral triangle. Preferably, however, it is often the case that a large as possible force transmission surface is present.

The support region can be rotationally symmetrical, in contrast to the insertion geometry. In particular, the support region can be conical as already mentioned, but can also be concave in a cup-like manner or possibly convex, and a course that is at least regionally cylindrical is also possible.

The support region can encompass the abutment in an accurately fitting manner, by which means a sealing of the recess is also rendered possible. The implant can include in particular an inner cone in the support region, wherein the abutment in an apical region can include a support portion that forms a corresponding outer cone. The inner cone and the outer cone each form at least one conical wedging surface, these being adapted to one another in pairs, by which means the implant and the abutment can be connected to one another by a wedging connection.

In embodiments, the abutment includes a rotation lock structure that engages into the insertion geometry in the put-together state. This structure can likewise engage into the insertion geometry in an accurately fitting manner. In alternative embodiments, one can envisage the rotation lock structure having an x*n-digit rotation geometry about the axis, wherein x is a natural number that is larger than one. In these embodiments, a rotation position of the abutment with respect to the implant can be fixed in n times x discrete rotation positions by way of receiving the rotation lock structure of the abutment into the insertion geometry of the implant. This can be advantageous if, for reasons of a favourable as possible force introduction on rotating in, the insertion geometry (rotating-in geometry) has a low rotation symmetry (for example, a merely three-fold one). Due to this approach, despite this, many possible relative rotation positions are possible, which can always be of significance if the abutment is angled or has a structure that otherwise deviates from the rotation symmetry about the axis (disregarding the rotation lock structure).

The implant system can further include a cap for the process of ingrowth, via which cap the gingiva is sutured after the implantation of the anchoring part, until the implant (anchoring part) has healed in, and/or at least one gingiva shaper, which is temporarily fastened to the anchoring part instead of the abutment and permits an ongrowth of the gingiva in the shape that is to be desired later. The cap and/or the gingiva shaper can be ceramic or also be manufactured of a suitable plastic, and metallic embodiments are also considered for these temporary elements.

In this text, the terms “coronally” and “apically” with regard to the elements of the implant system are used as is the case for the implanted state, in which the anchoring part is screwed into the jawbone and the abutment (and possibly the superstructure) is fastened to the anchoring part, analogously to the natural tooth, i.e. “apically” is the direction towards the root tip, into the inside of the jawbone and “coronally” is the opposite direction towards the tooth crown.

### BRIEF DESCRIPTION OF THE DRAWINGS

The subject-matter of the invention is hereinafter represented by way of preferred embodiment examples, which are represented in the accompanying drawings. In part, scales that are different from figure to figure are shown:

FIG. 1 an implant system with an anchoring part, abutment, abutment screw and screw tool, in a front elevation;

FIG. 2 a sectioned representation (sectioned parallel to the axis) of the system according to FIG. 1;

FIG. 3 a representation according to FIG. 2 of the system during the putting-together;

FIG. 4 a view of the anchoring part with an insertion tool;

FIG. 5 a sectioned representation according to FIG. 4;

FIG. 6 a sectioned representation of the anchoring part and insertion tool during the engagement of the insertion tool into the recess of the anchoring part; and

FIG. 7 a detail of FIG. 6.

### DETAILED DESCRIPTION OF THE INVENTION

In the figures, the same reference numerals indicate equal or analogous parts.

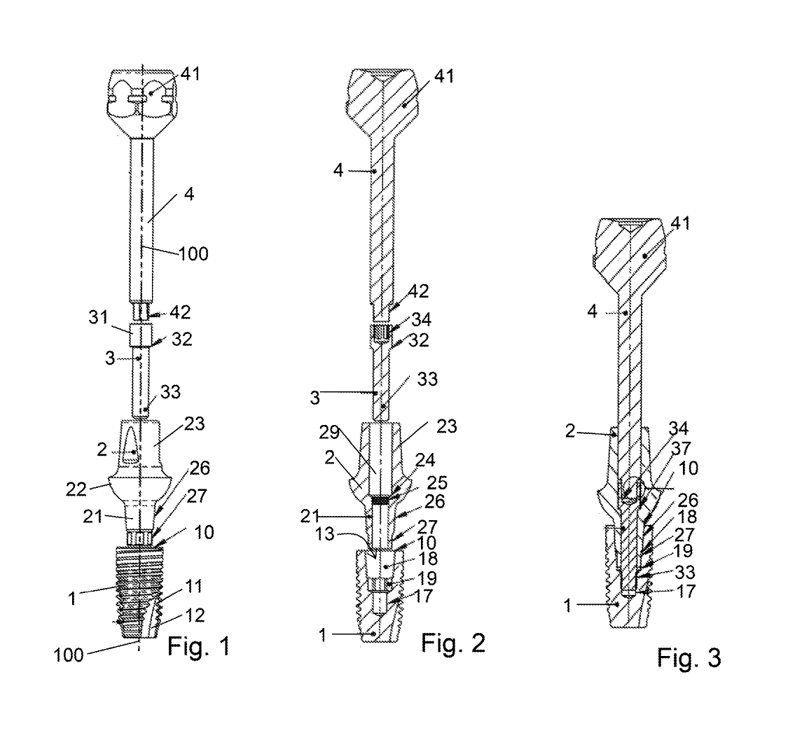

The dental implant (anchoring part 1), which, for example, is represented in FIGS. 1-3 includes an outer thread 11 that extends over almost the entire length, almost up to the coronal end and defines an axis 100. The anchoring pat 1 has an apically slightly tapering shape, so that in cross section along a plane parallel to the axis 100 as a whole it is slightly convexly arcuate with the exception of thread deepenings and apical clamping grooves 12 and as a whole merges continuously from a coronally roughly cylindrical into an apically tapering shape. The outer thread 11 has a non-constant thread depth and is for fashioned to be self-cutting.

A recess 13, into which a fastening post 21 of an abutment 2 projects in the completed, implanted state is open towards the coronal end. The recess forms a coronal support region 18, apically of this an insertion geometry region 19 and apically of this an inner thread region 17. The support region 18 as a whole has a conical course with a coronally slightly widening diameter. In the insertion geometry region 19, the recess forms an insertion geometry by way of it not running rotationally symmetrically about the axis 100. In the represented embodiment example, an equilateral hexagon with rounded corners is formed in the cross section along a plane perpendicular to the axis, wherein it is cylindrical in the sense that it has a constant cross section along the axis. The inner threaded region is provided with an inner thread, which is matched to a screw thread of the abutment screw.

In the represented embodiment example, the anchoring part is a bone-level implant, concerning which the implant shoulder 10 with a circular edge that terminates the inner connection between the anchoring part 1 and the abutment 2 is at bone-level. The invention however can also be applied to other two-part implant systems, specifically to tissue-level implants, concerning which, for example, a transgingival region that is widened, for example in a tulip-like manner, is formed on the anchoring part coronally of the enossal part with the thread.

Apart from the fastening post 21, the abutment 2 includes a coronal post 23 for fastening a superstructure. A transgingival region 22, which is adapted, for example, to the expected course of the gingiva, is formed apically of this. The shapes of such a transgingival region 22 as well as of the post 23—here drawn with an optional flattening—including its angle to the fastening post and therefore to the axis 100 are adapted to the specific requirements and depending on where the implant is placed or has been placed in the jaw. In particular, an implantation set with at least one anchoring part can include several different abutments for different implantation situations.

A support portion 26, which in its shape is matched to the support region 18, is formed on the fastening post 21, and a rotation lock structure 27 is formed apically of this. The rotation lock structure has a hexagonal shape, likewise with rounded edges.

The abutment includes an axially continuous opening 29 for the abutment screw. This further forms a shoulder 24 for the head of the abutment screw. Furthermore, an optional abutment inner thread 25 for a so-called retrieval tool (a tool for removing the abutment) is present at the opening.

The abutment screw 3 has a shank region with the outer thread 33, which is matched to the inner thread of the anchoring part, as well as a screw head 31, which forms a screw stop 32 in the apical direction. A coronally open recess with an engagement structure 34, designed here in the shape in an internal hex, for a screwdriver 4, is formed in the screw head. The screwdriver 4 accordingly includes an engagement portion, in the represented example with a hexagonal structure. In embodiments, the engaging structure and the engagement portion taper slightly apically, i.e. are shaped in a slightly conical manner, so that the screwdriver easily wedges with the abutment screw given a slight pushing-in and therefore holds this on the screwdriver. Coronally, the screwdriver includes an adapter head 41, for example for a ratchet with an adjustable torque.

FIG. 3 shows the implant system during the procedure of the abutment fastening, before the application of the superstructure (tertiary structure). The thread 33 of the abutment screw 3 is received apically by the respective inner thread of the anchoring part 1. The abutment screw 3 fixes the abutment 2 relative to the anchoring part with regard to a pulling-apart in the axial direction. Herein, the abutment is supported and guided in the support region by way of the supporting portion 26 bearing extensively on the inner surface of the recess there. The abutment is secured in this position with respect to rotations, by way of the rotation lock structure 27 engaging into the coronal region of the insertion geometry.

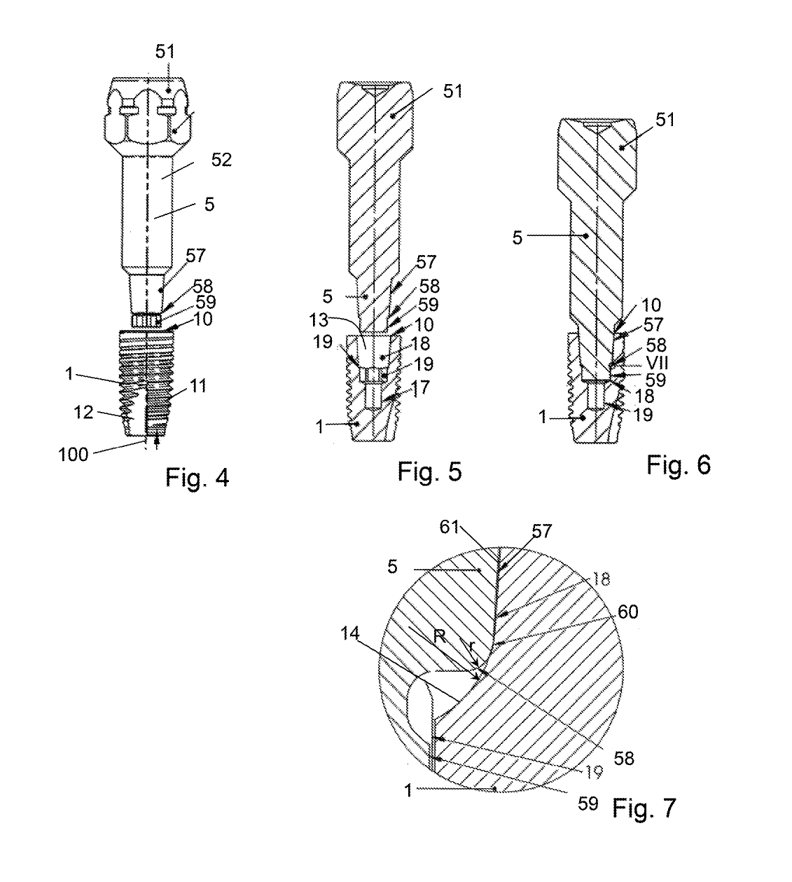

FIGS. 4-6 show the anchoring part 1 with the insertion tool 5. The insertion tool 5 as the previously described screwdriver includes an adapter head 51, for example for a ratchet with an adjustable torque. A guide portion 57, which runs conically as the support region 18, is formed apically of a shank region 52, which connects to the adapter head. The—optional—conical guide portion 57 simplifies the introduction, aligned along the axis, of the insertion tool 5 into the recess 13 by the implantologist. The engagement portion 59 is designed with an outer structure, which corresponds to the engagement region 19, apically of the guide portion. In the represented embodiment example, the engagement portion 59 has a hexagonal structure with a tangential rounding. On inserting (rotating-in) the implant, this design permits the engagement portion to be present on the insertion geometry not only at individual points, but at least along axial lines.

As one can see particularly well in FIG. 7, which shows a detail VII (FIG. 6), the insertion tool is rounded with a minimal radius of curvature r, in the transition portion 58 between the engagement portion 59 and the guide portion 57.

The transition region 14 between the conical support region 18 and the inner structure region 19 is likewise arcuate in the represented embodiment example (here too, what is meant by arcuate is a curvature not only in the tangential/circumferential direction, but indeed also in a section along a plane parallel to the axis 100), but with a smaller curvature in the longitudinal a section than the curvature of the transition portion. The curvature of the transition region, where the transition portion of the insertion tool abuts on this, in any case should be smaller in the longitudinal section than the curvature of the transition portion (i.e. the radius of curvature R of the transition region 14 should be larger than the radius of curvature r of the transition portion). This also includes a curvature of zero, i.e. the possibility of the transition region not being arcuate at all, but conical, with a steeper cone angle than the support region.

On account of this rounding, a stop for the introduction of the insertion tool firstly results. Secondly, a wedging connection 60 results on the one hand between the tool and on the other hand the anchoring part. It is not necessary for the tool to bear on the support region of the recess in the region of the guide portion 57. In contrast, the conical guide portion is mounted in the recess in a floating manner and a very thin gap 61 arises between the insertion tool and the anchoring part in the represented embodiment. This does not exclude slight contacts occurring between the insertion tool and the support region towards the coronal end on account of material elasticity and manufacturing tolerances.

The conicity of the guide portion 57 does not generally serve for the support of the insertion tool but solely for the guidance, which is why it is also optional given the presence of a conical support region 18 in the anchoring part.

The fact that the insertion tool does not load the support region is also advantageous with regard to avoiding damage to the anchoring part on inserting. Specifically, this prevents the insertion tool from loading the coronal region of the anchoring part where its material thickness is at a minimum.

For the application, the anchoring part is firstly implanted in the bone, wherein for this the bone can be prepared in the manner known per se, for example by way of a bore. The insertion tool is used for implantation, wherein the anchoring part holds on the insertion tool on application thanks to the procedure according to the invention, wherein however despite such, this is simple to remove in an almost force-free manner after implantation. The subsequent steps with the healing-in phase (possibly with a cap which is envisaged for this and is placed upon the anchoring part), fastening of a temporary restoration and/or of the abutment, adaptation of the tertiary structure etc. can be carried out as known per se from two-part implant systems.

1. A dental implant system comprising
an anchoring part for anchoring in bone tissue, wherein the anchoring part is manufactured of a ceramic material,
and an insertion tool,
wherein the anchoring part comprises an outer thread which defines an axis,
wherein the anchoring part comprises a recess for an engagement of a fastening post of an abutment as well as for an engagement of the insertion, said recess being open towards a coronal end,
wherein the recess comprises an inner structure region with an inner structure forming an insertion geometry for interacting with a corresponding outer structure of the insertion tool, and wherein the insertion tool comprises an engagement portion with a corresponding outer structure,
wherein the recess coronally of the inner structure region forms a support region, wherein a transition region with a surface, which in the longitudinal section is concavely arcuate and/or conical, is formed between the support region and the inner structure region,
wherein the insertion tool coronally of the engagement portion forms a widening merging into the engagement portion via a transition portion,
and wherein a surface of the insertion tool in a longitudinal section is convexly arcuate in the region of the transition portion, so that a wedging connection between the insertion tool and the anchoring part results in this region when the transition portion (58) abuts on the transition region.

2. The system according to claim 1, wherein the support region is conical.

3. The system according to claim 1, wherein the transition region is arcuate in a longitudinal section, wherein where the transition portion abuts on the transition region, a curvature of the transition region in the longitudinal section is smaller than a curvature of the transition portion in the longitudinal section.

4. The system according to claim 1, wherein the transition region is conical where the transition portion abuts on the transition region.

5. The system according to claim 1, wherein the recess apically of the engagement portion forms an inner threaded region with an inner thread.

6. The system according to claim 1, wherein the widening of the insertion tool forms a guide portion, whose shape qualitatively corresponds at least approximately to the shape of the support region.

7. The system according to claim 6, wherein the guide portion is conical.

8. The system according to claim 1, wherein the anchoring part is designed as a bone-level anchoring part.

9. The system according to claim 1, wherein the shapes of the support region and of the insertion tool are matched to one another such that when the engagement portion of the insertion tool is inserted into the recess, and the transition portion abuts on the transition region, a gap between the insertion tool and the inner wall of the recess and which extends in the peripheral direction is formed coronally of the transition region.

10. The system according to claim 1, comprising an abutment of a ceramic material, with a fastening post for engaging into the recess.

11. The system according to claim 10, wherein the fastening post forms a support portion, which in its shape is matched to the support region in an exactly fitting manner.

12. The system according to claim 10, further comprising an abutment screw, wherein the abutment comprises an opening which is continuous in the axial direction and into which the abutment screw can be inserted, wherein the abutment screw is configured, for a fastening of the abutment to the anchoring part, to engage into an inner thread which is formed by the recess.

13. The system according to claim 12, wherein the abutment screw is manufactured from a ceramic material.

14. The system according to claim 11, further comprising an abutment screw, wherein the abutment comprises an opening which is continuous in the axial direction and into which the abutment screw can be inserted, wherein the abutment screw is configured, for a fastening of the abutment to the anchoring part, to engage into an inner thread which is formed by the recess.

15. The system according to claim 14, wherein the abutment screw is manufactured from a ceramic material.
